(19) United States
(12) Patent Application Publication
(10) Pub. No.: US 2003/0102270 A1
(43) Pub. Date: Jun. 5, 2003

(54) Device for electrochemical treatment of a liquid and process-technical arrangement having such a device and process for operating such a process-technical

(76) Inventor: Meinolf Schoeberl, Prien (DE)

Correspondence Address: TOWNSEND AND TOWNSEND AND CREW, LLP, TWO EMBARCADERO CENTER, EIGHTH FLOOR, SAN FRANCISCO, CA, 94111-3834, US

(21) Appl. No.: 10/286,661

(22) Filed: Nov. 1, 2002

(30) Foreign Application Priority Data
Nov. 2, 2001 (DE) 10153897.9

(51) Int. Cl. B03C 1/00

(52) U.S. Cl. 210/748

(57) ABSTRACT

A device for electrochemical treatment of a liquid, in particular for sterilising water, is provided with a tubular housing jacket, which is designed as a first electrode body (2) at least on its inner side, a central axial second electrode body (4), a first and second cover part (7, 8), which closes in each case an axial end of the tubular housing jacket, so that an annular gap chamber (6) is formed between the two electrode bodies (2, 4), an inlet channel (9) provided at the first axial end for the liquid, which flows into the annular gap chamber (6), an outlet channel (12) provided at the second axial end for the liquid, which likewise flows into the annular gap chamber (6) and a current supply unit (40), which is electrically connected to the first and second electrode body (2, 4), wherein one electrode body is intended as anode (A) and the other electrode body as cathode (K). In such a device, the outlet channel (12) flows into the annular gap chamber (6) in the region of the surface (4′) of the electrode body intended as anode (A) and thus has at least one mouth.

The invention relates to a device for electrochemical treatment of a liquid, in particular for sterilising water, according to the preamble of patent claim 1. It also relates to a process-technical arrangement using such a device and a process for operating such a process-technical arrangement.

A generic device for electrochemical treatment of a liquid is known from German Offenlegungsschrift 3 523 026. The device designated there as oxidation chamber has an annular gap chamber between a central anode and a cathode designed as an annular jacket, through which water is passed. As a result of the electrical voltage applied at the anode and cathode, the water flowing through the annular gap chamber is sterilised and prepared according to the principle of anodic oxidation.

An accompanying effect of this electrochemical treatment of water is the deposition of lime or other mineral materials present in the water on the cathode, which may lead in an extreme case to the fact that the annular gap chamber is clogged with deposited lime and thus flow through the annular gap chamber is rendered more difficult or impossible.

In order to avoid these deposits on the cathode, attempts have already been made to mechanically clean the cathode surface during operation. Hence, German Offenlegungsschrift 3 708 947 discloses a similar oxidation chamber, in which the central anode is arranged to be driven rotatably in the device for electrochemical treatment and is provided on its periphery with scrapers running in axis-parallel manner which scrape deposits from the cathode surface on rotation of the anode. However, such a construction is technically extremely complex and therefore expensive to produce and additionally expensive to maintain.

The aim of the present invention is to indicate a generic device for electrochemical treatment of a liquid, in particular for sterilising water, which can be operated without maintenance over a preset period of time with simple and thus cost-effective structure. This object is achieved according to patent claim 1 in that the outlet channel flows into the annular gap chamber in the region of the surface of the electrode body intended as anode.

Due to this particular arrangement of the mouth of the outlet channel in the region of the surface of the electrode body intended as anode, the narrowest pipe cross-section potentially exposed to conversion to lime in the device is protected from clogging due to lime deposits in reliable manner. Tests by the patent applicant have shown this position of the mouth of the outlet channel claimed in claim 1 as an optimum position for preventing conversion to lime.

It is thus particularly advantageous when the at least one mouth of the outlet channel flows into the annular gap chamber in the region of the surface of the electrode body intended as anode, which, seen in radial direction, at least partly lies opposite a region of the surface of the electrode body intended as cathode.

It is particularly advantageous when the at least one mouth of the outlet channel into the annular gap chamber is provided in the surface of the electrode body designed as anode.

However, the at least one mouth of the outlet channel into the annular gap chamber may also preferably be placed in the immediate vicinity next to the surface of the electrode body intended as anode.

In a preferred embodiment, the device of the invention is designed so that the central axial electrode body is intended as anode and that the tubular electrode body is intended as cathode. In this embodiment, it is advantageous that determining the tubular electrode body as cathode, which surrounds the central anode coaxially, ensures a considerably larger cathode surface with respect to the anode surface. The lime deposits are thus deposited on the, compared to the surface of the central rod-like electrode (anode), considerably larger surface of the tubular electrode surface (cathode) surrounding the latter, so that the rate of build-up of a lime layer in the radial direction (towards the anode) is considerably reduced with respect to the other alternative with central rod-like cathode.

Additionally, as a result of this electrode arrangement there is a significantly lower cathodic current density compared to the current density at the central anode, which leads to a very advantageous slow reaction rate for lime deposition.

In a further preferred embodiment, the radial distance between the anode surface and the cathode surface has dimensions so large that in a preset operating time period, even under unfavourable operating conditions, no lime bridges may be produced between anode and cathode. Such unfavourable operating conditions are defined, for example by very high water hardness, very poor conductivity of the water and/or a low chloride concentration in the water.

The inlet channel is also preferably designed such that it flows into the annular gap chamber approximately tangentially to the surface of the anode and/or the cathode and preferably at an angle to the longitudinal axis of the device, in order to impart spin to the liquid flow in the annular gap chamber. This exposure to spin for the flow entering the annular gap chamber has proved to be particularly advantageous, since the specific lime build-up on the cathode surface thus takes place more homogeneously in the peripheral direction than for inflow not burdened with spin.

It has thus proved to be particularly advantageous when the cross-sectional area of the mouth(s) of the inlet channel has dimensions so that the inflow rate of the liquid into the annular gap chamber is higher than the axial through-flow rate defined due to the cross-sectional area of the annular gap and the liquid volume per unit of time flowing through the latter. The inflow rate preferably lies a multiple above this axial through-flow rate.

A process-technical arrangement for electrochemical treatment of a liquid, in particular for sterilising water, having a device according to the invention is characterised in that the outlet channel of the device is connected to the inlet of a filter via a fluid pipe, in that the outlet of the filter is connected to a pipe which flows into a buffer container for the liquid, and in that the consumer is supplied from the buffer container by a removal pipe. In this arrangement, deposit particles possibly discharged from the annular gap are caught in the filter. Supplying the consumer from the buffer container additionally ensures that continuous operation of the device at constant, optimised volume flow is facilitated, even if spontaneous high liquid consumption occurs.

It is particularly advantageous when a backflow pipe branches off from the removal pipe, preferably shortly before the consumer, and leads to the inlet channel of the device for electrochemical treatment and when a valve is provided which releases or blocks the flow through the backflow pipe. This design of the process-technical arrangement permits ensuring that the proportion of reagents produced in the device acting on the liquid, for example free oxidants, is always adequately high in the buffer container in order to prevent, for example reinfection of the liquid present in the buffer container and in the supply pipes to individual consumers over a longer period of time.

Alternatively to this, in the removal pipe, preferably shortly before the consumer, an outlet device, which can be blocked by a valve, may be provided in order to guide liquid from the buffer container and the removal pipe into a drain. This somewhat simpler design of the process-technical arrangement dispenses with the recycling of the liquid to the device for electrochemical treatment with respect to the previous design, so that in this design freshly prepared water is always passed through the device and the filter into the buffer container.

The process-technical arrangement of the invention is preferably operated in a process, in which liquid, in particular water, is passed from a water supply or from an existing water pipe system initially through the device for electrochemical treatment, wherein an electrical voltage is applied at its anode and cathode, in which the liquid emerging from the device is passed through a filter, in which the liquid emerging from the filter is passed to a buffer container and in which a consumer is supplied from the liquid supply in the buffer container and which is characterised in that the liquid content of the buffer container and preferably also of the removal pipe is replaced at intervals by liquid newly supplied from the device.

The invention is illustrated in more detail below using an example with reference to the drawing; in the latter:

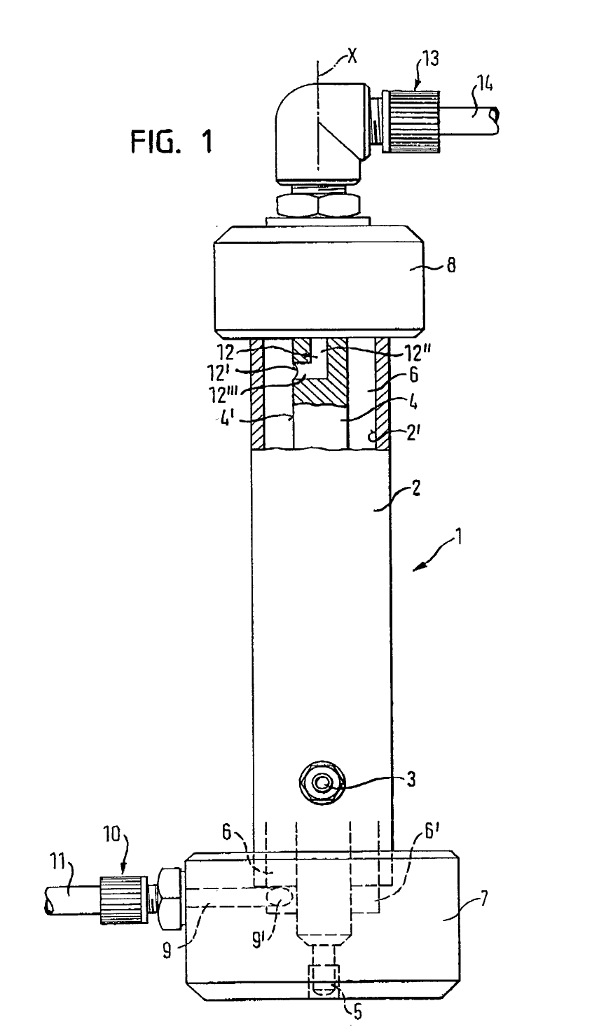

FIG. 1 shows a partly sectioned view of the device of the invention and

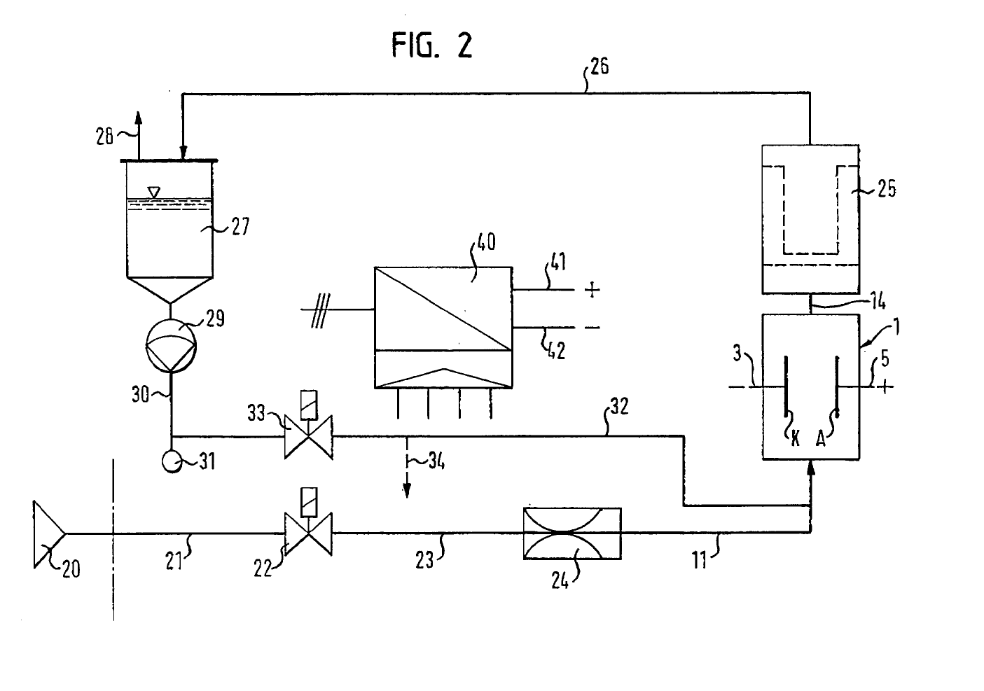

FIG. 2 shows a diagram of a process-technical arrangement according to the invention.

FIG. 1 shows a device 1 for electrochemical treatment of a liquid, in particular for sterilising water. This device is a so-called tubular reactor for anodic oxidation. A tubular outer electrode body 2 is electrically connected to a current supply unit 40 by means of a first electrical connection part 3.

A rod-like round inner electrode body 4, which is likewise electrically connected to the current supply unit 40 via a second electrical connection part 5, is provided coaxially within the tubular outer electrode body 2.

The two electrode bodies 2, 4 are thus connected to the current supply unit so that the inner electrode body 4 forms an anode A and the outer electrode body a cathode K.

An annular gap chamber 6 is formed between the radially inner surface 2′ of the tubular outer electrode body 2 and the radially outer surface 4′ of the rod-like inner electrode body 4.

The outer electrode body 2 forming a tubular housing jacket of the device 1 is closed at its axial ends in each case by a cover part 7, 8, The two cover parts 7, 8 serve additionally for storing the rod-like inner electrode body 4.

The first lower cover part 7 in FIG. 1 is provided with an inlet channel 9, which flows essentially tangentially into a lower extension 6′ of the annular gap chamber 6. The inlet channel 9 is connected to an inlet pipe 11 via a connection piece 10.

The second, upper cover part 8, through which the rod-like inner electrode body 4 is passed in axial direction sealed by its upper end, is provided at the upper end in

FIG. 1 of the tubular outer electrode body 2. The rod-like inner electrode body 4 is provided in this region with an axial bore 12″, which transfers into a radial bore 12′″ within the second cover part 8 or shortly below the latter, which flows into the annular gap chamber 6 at the radially outer surface 4′ of the rod-like inner electrode body 4. The axial bore 12″ and the radial bore 12′″ together form an outlet channel 12. This outlet channel 12 is connected to an outlet pipe 14 via a connection piece 13 attached to the upper free end of the rod-like inner electrode body 4.

Liquid (for example water) supplied by the inlet pipe 11 enters through the inlet channel 9 and its mouth 9′ into the annular gap chamber 6 with essentially tangential flow direction, so that spin flow directed from bottom to top is produced within the annular gap chamber 6. The liquid being moved upwards in the annular gap chamber 6 is exposed to the electrochemical effect between anode A and cathode K. The liquid rises as far as the mouth 12′ of the outlet channel 12 and leaves through the latter from the annular gap chamber 6. It then flows through the upper connection piece 13 into the outlet pipe 14.

FIG. 2 shows a process-technical arrangement which has the device 1 shown in FIG. 1 for electrochemical treatment of a liquid.

The water is supplied from a liquid or water reservoir or a water supply connection 20 through a first supply pipe section 21 to a blocking solenoid valve 22. If this valve is opened, the water flows from the valve 22 through a second supply pipe section 23 to a flow regulator 24. The inlet pipe 11 leading to the device 1 is connected to the outlet of the flow regulator 24. The outlet pipe 14 leading out from the device 1 guides the water treated in the device to a filter 25, in which on the one hand suspended matter, such as for example lime particles, are deposited and in which on the other hand fine gas bubbles being produced in the device are agglomerated to form larger gas bubbles, so that the filter 25 also contributes considerably to degassing of the treated water. A connecting pipe 26 leads from the filter 25 to a buffer container 27, into which the water removed from the filter 25 together with the larger gas bubbles being produced there is passed. The gas bubbles rise in the buffer container 27 and leave the latter through a degassing pipe 28.

A pump 29 is arranged at the outlet of the buffer container 27 and if needed pumps water from the buffer container 27 through a removal pipe 30 to a consumer 31, which is only shown schematically here. The consumer 31 may be, for example a spraying device in a dental treatment device.

Shortly before the consumer 31, a backflow pipe 32 branches off, which may be opened via a further solenoid valve 33. The backflow pipe 32 leads to the inlet pipe 11 and flows into the latter shortly before its entry into the device 1.

Alternatively to the backflow pipe 32, an outlet device 34 drawn as a dashed line here may also be provided behind the further solenoid valve 33, from which the water in the buffer container 27 and in the removal pipe 30 may be discharged if needed into a drain by opening the solenoid valve 33.

A current supply unit 40 is connected to the electrical connection part 3 of cathode 3 or to the electrical connection part 5 of anode A via electrical connection leads 41, 42.

An example for the use of the device according to the present invention are the sterilisation and treatment of utility water for dental treatment units. In this case the device is integrated in a feed line or feed pipe for utility water and is flown through either in a feed operation mode for feeding fresh water to the dental treatment unit or in a recirculation mode within the utility water circulation in the dental treatment unit. The device may also be provided as a central water treatment unit for a plurality of dental treatment units.

The invention is not restricted to the above exemplary embodiments, which serve only to generally explain the core concept of the invention. Within the framework of the scope of protection, the device of the invention may rather also assume other embodiments than those described above. The device may thus have particular features which represent a combination of the particular individual features of the claims.

Reference numbers in the claims, the description and the drawings serve only for better understanding of the invention and should not restrict the scope of protection.

Reference Number List

1 Device

2 Tubular outer electrode body

2′ Radially inner surface

3 Outer electrical connection part

4 Rod-like inner electrode body

4′ Radially outer surface

5 Electrical connection part

6 Annular gap chamber

6′ Lower extension of the annular gap chamber

7 First cover part

8 Second cover part

9 Inlet channel

9′ Mouth

10 Connection piece

11 Inlet pipe

12 Outlet pipe

12′ Mouth

12″ Axial bore

12′″ Radial bore

13 Connection piece

14 Outlet pipe

20 Liquid reservoir

21 First supply pipe section

22 Blocking solenoid valve

23 Second supply pipe section

24 Flow regulator

25 Filter

26 Connecting pipe

27 Buffer container

28 Degassing pipe

29 Pump

30 Removal pipe

31 Consumer

32 Backflow pipe

33 Solenoid valve

34 Outlet device

40 Current supply unit

41 Electrical connection lead

42 Electrical connection lead

A Anode

K Cathode

X Longitudinal axis

1. Device for electrochemical treatment of a liquid, in particular for sterilising water, having
a tubular housing jacket, which is designed as a first electrode body (2) at least on its inner side,
a central axial second electrode body (4),
a first and second cover part (7, 8), which closes in each case an axial end of the tubular housing jacket, so that an annular gap chamber (6) is formed between the two electrode bodies (2, 4),
an inlet channel (9) provided at the first axial end for the liquid, which flows into the annular gap chamber (6),
an outlet channel (12) provided at the second axial end for the liquid, which likewise flows into the annular gap chamber (6) and
a current supply unit (40), which is electrically connected to the first and second electrode body (2, 4), wherein one electrode body is intended as anode (A) and the other electrode body as cathode (K),
characterised in that the outlet channel (12) flows into the annular gap chamber (6) in the region of the surface (4′) of the electrode body intended as anode (A) and thus has at least one mouth.

2. Device according to claim 1, characterised in that the mouth (12′) of the outlet channel (12) flows into the annular gap chamber (6) in the region of the surface of the electrode body intended as anode (A), which, seen in radial direction, at least partly lies opposite a region of the surface of the electrode body intended as cathode (K).

3. Device according to claim 1 or 2, characterised in that the mouth (12′) of the outlet channel (12) into the annular gap chamber (6) is provided in the surface of the electrode body designed as anode (A).

4. Device according to claim 1 or 2, characterised in that the mouth (12′) of the outlet channel (12) into the annular gap chamber (6) is placed in the immediate vicinity next to the surface of the electrode body intended as anode (A).

5. Device according to one of the preceding claims, characterised in that
the central axial electrode body (4) is intended as anode (A) and in that
the tubular electrode body (2) is intended as cathode (K).

6. Device according to one of the preceding claims, characterised in that the radial distance between the anode surface (4′) and the cathode surface (2′) has dimensions so large that in a preset operating time period, even under unfavourable operating conditions, no lime bridges may be produced between anode (4) and cathode (2).

7. Device according to one of the preceding claims, characterised in that the inlet channel (9) is designed such that it flows into the annular gap chamber (6) approximately tangentially to the surface of the anode (A) and/or the cathode (K) and preferably at an angle to the longitudinal axis (X) of the device through at least one mouth, in order to impart spin to the liquid flow in the annular gap chamber (6).

8. Device according to claim 7, characterised in that the cross-sectional area of the mouth(s) (9′) of the inlet channel (9) has dimensions so that the inflow rate of the liquid into the annular gap chamber (6) is higher than the axial through-flow rate defined due to the cross-sectional area of the annular gap (6) and the liquid volume per unit of time flowing through the latter.

9. Process-technical arrangement for electrochemical treatment of a liquid, in particular for sterilising water, having a device (1) according to one of the preceding claims,
wherein the outlet channel (12) of the device (1) is connected to the inlet of a filter (25) via a fluid pipe (14),
wherein the outlet of the filter (25) is connected to a pipe (26) which flows into a buffer container (27) for the liquid and
wherein the consumer (31) is supplied from the buffer container (26) by a removal pipe (30).

10. Process-technical arrangement according to claim 9, characterised in that
a backflow pipe (32) branches off from the removal pipe (30), preferably shortly before the consumer (31), and leads to the inlet of the device (1) for electrochemical treatment and in that
a valve (31) is provided which releases or blocks the flow through the backflow pipe (32).

11. Process-technical arrangement according to claim 9, characterised in that in the removal pipe (30), preferably shortly before the consumer (31), an outlet device (34), which can be blocked by a valve (33), is provided in order to guide liquid from the buffer container (27) and the removal pipe (30) into a drain.

12. Process for operating a process-technical arrangement according to one of claims 9 to 11,
wherein liquid, in particular water, is passed from a water supply or from an existing water supply system initially through the device (1) for electrochemical treatment, wherein an electrical voltage is applied at its anode (A) and cathode (K),
wherein the liquid emerging from the device (1) is passed through a filter (25),
wherein the liquid emerging from the filter (25) is passed to a buffer container (27) and,
wherein a consumer (31) is supplied from the liquid supply in the buffer container (27),
characterised in that the liquid content of the buffer container (27) and preferably also of the removal pipe (30) is replaced at intervals by liquid newly supplied from the device (1).
